(19) United States
(12) Patent Application Publication
(10) Pub. No.: US 2016/0238136 A1
(43) Pub. Date: Aug. 18, 2016

(54) SLIDE RING SEAL WITH IMPROVED TORQUE TRANSMISSION

(71) Applicant: EagleBurgmann Germany GmbH & Co. KG, Wolfratshausen (DE)

(72) Inventors: Joseph Fichtner, Wolfratshausen (DE); Josef Gerg, Gaissach (DE); Alfred Matuschek, Ascholding (DE); Joachim Skrzidlo, Wolfratshausen (DE)

(73) Assignee: EagleBurgmann Germany GmbH & Co., KG, Wolfratshausen (DE)

(21) Appl. No.: 14/911,026

(22) PCT Filed: Mar. 17, 2014
(86) PCT No.: PCT/EP2014/055298

§ 371 Date: Mar. 31, 2016

(30) Foreign Application Priority Data
May 10, 2013 (DE) 10 2013 008 094.0

(51) Int. Cl. F16J 15/34; F16B 3/00

(52) U.S. Cl. CPC F16J 15/3464; F16B 3/00

(57) ABSTRACT

The invention relates to a mechanical seal arrangement, comprising at least one first mechanical seal having a rotating slide ring (2) and a stationary slide ring (3) which define a sealing gap (4) therebetween, a one-piece shaft bushing (5), an entrainment element (6) for transmitting a rotation of the shaft bushing (5) to the rotating slide ring (2), and at least one feather key (7) which is arranged between the shaft bushing (5) and the entrainment element (6) in order to permit torque transmission between the shaft bushing (5) and the entrainment element (6), wherein the feather key (7) comprises a base region (71) and an upper end region (72), and wherein the upper end region (72) is formed in an arcuate manner.

The present invention relates to a mechanical seal arrangement having a rotating slide ring and stationary slide ring, which permits improved transmission of torque to the rotating slide ring by means of at least one feather key.

Mechanical seal arrangements in different designs are known from the prior art. In this case, a problem surrounding mechanical seal arrangements is in particular torque transmission from a shaft or shaft bushing to the rotating slide ring. In this case, pins or the like are frequently used as entrainment elements. However, this leads to undesired openings/bores or weakened portions in the slide ring which can adversely affect the stability of the rotating slide rings in particular in a heavy-duty operation. Frequently, so-called entrainment elements are used for torque transmission and transmit the torque from one shaft bushing to the rotating slide ring. However, in this case the torque must also be transmitted from the shaft bushing to the entrainment element. DE 44 08 956 A1 discloses e.g. a mechanical seal arrangement in which torque is transmitted from a shaft via a feather key. However, in essence the feather keys used for torque transmission make in particular axial fixing more difficult as well as mounting of the mechanical seal arrangement which is typically effected by axially sliding the individual components of the mechanical seal arrangement over a shaft. In particular, an entrainment element is hitherto provided with an axial slit, into which the protruding part of the feather key engages. However, in this case it is not possible to position the entrainment element in an exact manner relative to the feather key.

Therefore, it is the object of the present invention to provide a mechanical seal arrangement which, having a simple structure and being simple and cost-effective to produce, permits effective axial fixing and simple mounting of the mechanical seal arrangement on the one hand and also permits reliable transmission of torque on the other hand.

This object is achieved by a mechanical seal arrangement having the features of claim 1. The dependent claims demonstrate preferred developments of the invention.

The mechanical seal in accordance with the invention and having the features of claim 1 has the advantage that simple mounting is possible and in particular the number of parts of the mechanical seal arrangement can be reduced. Furthermore, reliable torque transmission is permitted and an entrainment element which transmits torque from a rotation component, in particular a shaft bushing, to a rotating slide ring can be produced very simply and cost-effectively. In accordance with the invention, this is achieved by virtue of the fact that the feather key has a particular shape with a base region and an upper end region, wherein the upper end region is formed in an arcuate manner. Therefore, in comparison with the hitherto known feather keys, the feather key in accordance with the invention comprises an arched roof-shaped surface which is directed to the radial outer side.

In a particularly preferred manner, the entrainment element comprises an axial bearing surface, against which the feather key lies. Therefore, during mounting of the mechanical seal arrangement the feather key serves as a stop and the entrainment element can be slid on as far as to a defined position, namely at the position where the entrainment element lies against the feather key. As a result, it is possible to precisely position the entrainment element and thus also the rotating slide ring which is held by the entrainment element.

In a particularly preferred manner, the upper end region of the feather key has a semi-circular cross-section. This provides a symmetrical feather key which can be mounted in a particularly simple manner.

In a further preferred manner, the feather key comprises a planar bearing surface which is in contact with the axial bearing surface of the entrainment element. The planar bearing surface of the feather key is preferably perpendicular to a longitudinal axis of the mechanical seal arrangement.

In accordance with a preferred alternative embodiment of the invention, the feather key comprises at least one first rounded end face. In a particularly preferred manner, the feather key comprises a second rounded end face. In particular, if both end faces are rounded, the feather key thus comprises an upper arcuate end region and the two rounded end faces and therefore comprises a total of three curved surfaces.

In a further preferred manner, the entrainment element comprises a recess for partially receiving the feather key, wherein the recess is arcuate. As a result, the entrainment element can be provided in a particularly cost-effective manner. The recess is preferably produced by means of a machining process, e.g. milling.

Preferably, the mechanical seal arrangement in accordance with the invention comprises a multiplicity of feather keys which are arranged at uniform spaced intervals along the periphery of the shaft bushing.

In a further preferred manner, the mechanical seal arrangement comprises, in addition to the first mechanical seal, a second mechanical seal having a second rotating slide ring and a second stationary slide ring. Such mechanical seal arrangements having two mechanical seals are also defined as tandem arrangements. In this case, the inventive concept of the specifically formed feather key has a very advantageous effect in particular in terms of mounting because such tandem arrangements have a relative long axial design size.

Preferred exemplified embodiments of the invention will be described in detail hereinafter with reference to the accompanying drawing. Like parts or parts which function in a like manner are each designated by like reference numerals. In the drawing:

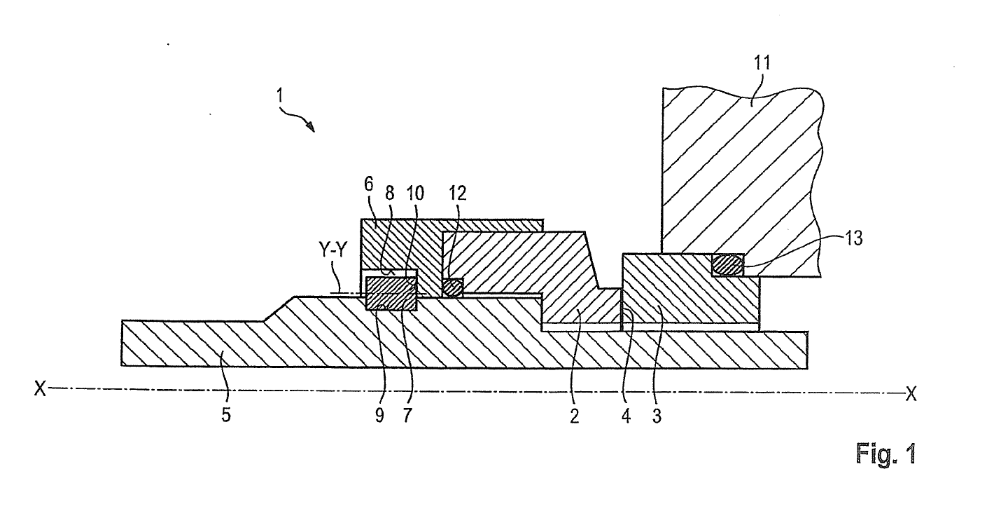

FIG. 1 shows a schematic sectional view of a mechanical seal arrangement in accordance with a first exemplified embodiment of the invention,

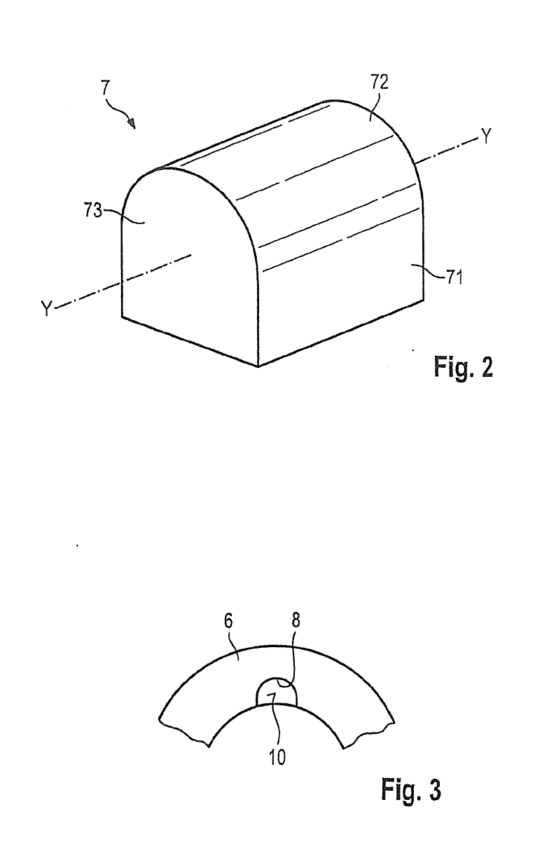

FIG. 2 shows a perspective view of a feather key of FIG. 1,

FIG. 3 shows a schematic end-face view of an entrainer of FIG. 1,

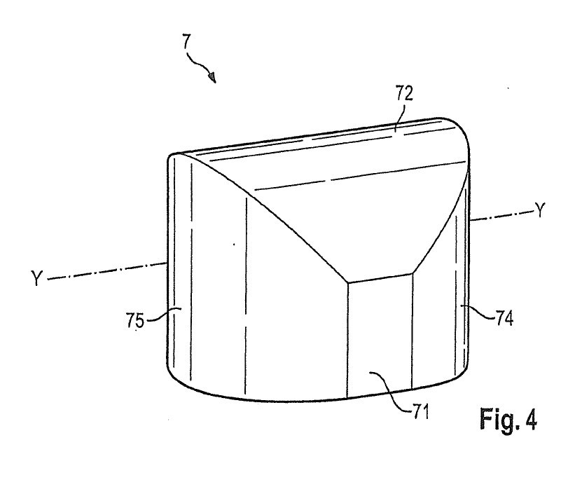

FIG. 4 shows a schematic, perspective view of a feather key in accordance with a second exemplified embodiment of the invention, and

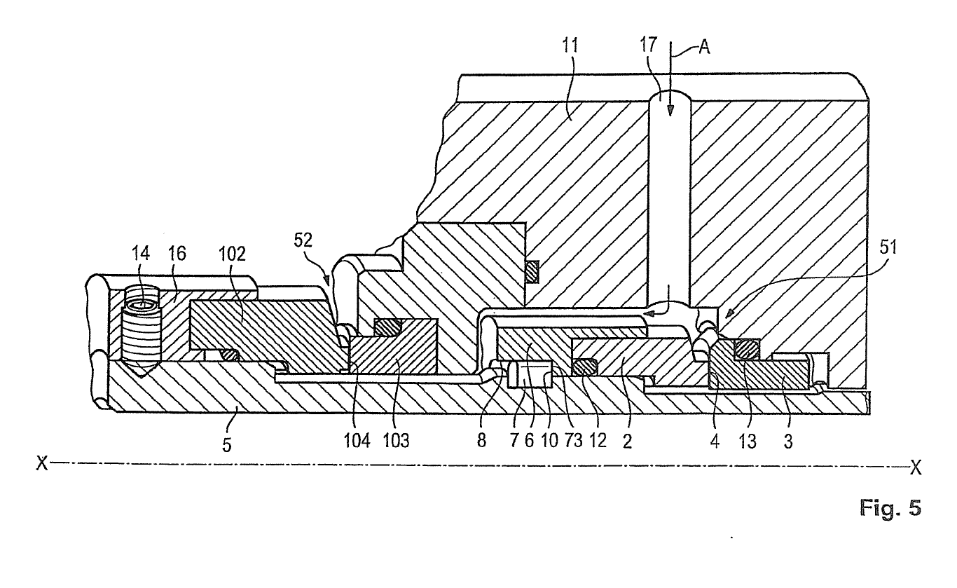

FIG. 5 shows a schematic sectional view of a mechanical seal arrangement in accordance with a third exemplified embodiment of the invention.

A mechanical seal arrangement 1 in accordance with a first exemplified embodiment of the invention will be described in detail hereinafter with reference to FIGS. 1 to 3.

As can be seen in FIG. 1, the mechanical seal arrangement 1 comprises a mechanical seal having a rotating slide ring 2 and a stationary slide ring 3 which define a sealing gap 4 therebetween.

Furthermore, the mechanical seal arrangement comprises a one-piece shaft bushing which is arranged on a shaft, not shown, and rotates therewith. In FIG. 1, a central axis of the mechanical seal arrangement is designated by the reference X-X.

Furthermore, the mechanical seal arrangement comprises an annular entrainment element 6 which transmits a rotation of the shaft bushing 5 to the rotating slide ring 2. This can be effected by means of an interference fit or by means of further transmission elements, such as e.g. pins. A feather key 7 is provided for torque transmission between the shaft bushing 5 and the entrainment element 6. The feather key 7 is arranged in a first recess 8 in the entrainment element 6 and a second recess 9 in the shaft bushing 5.

The first recess 8 in the entrainment element 6 is a milled recess, i.e. the recess is provided by means of a milling process. This produces at the end of the first recess 8 a bearing surface 10. The bearing surface 10 of the recess 8 lies in a plane which is perpendicular to the central axis X-X.

FIG. 3 shows the end-face view of the entrainment element 6 which shows the arcuate shape of the first recess 8. The first recess 8 is formed on an inner periphery of the entrainment element 6. The end of the first recess 8 forms the planar bearing surface 10.

The stationary slide ring 3 is connected to a housing 11. The reference numerals 12 and 13 designate O-rings.

The feather key 7 is shown in detail in FIG. 2. As can be seen in FIG. 2, the feather key 7 comprises a base region 71 and an upper end region 72 which is formed in an arcuate manner. The upper end region 72 merges directly into the base region 71. In this exemplified embodiment, the upper end region 72 has a semi-circular cross-section. The axis Y-Y designates a longitudinal axis of the feather key 7. As can be seen in FIG. 1, the feather key 7 is arranged in the mechanical seal arrangement such that the longitudinal axis Y-Y of the feather key 7 is in parallel with the central axis X-X of the mechanical seal arrangement.

The feather key 7 further comprises a planar bearing surface 73 which is in parallel with the bearing surface 10 on the entrainment element 6 when the feather key is in the mounted state. In the mounted state, the two bearing surfaces of the entrainment element 6 and of the feather key 7 thus contact one another.

The mechanical seal arrangement in accordance with the invention is mounted in such a manner that firstly the feather key 7 is placed into the shaft bushing 5 and subsequently the entrainment element 6 is slid on in the axial direction until the bearing surface 10 of the entrainment element 6 comes into contact with the planar bearing surface 73 of the feather key. Since a fitted connection is formed between the feather key 7 and the second recess 9 in the shaft bushing 5, a position of the entrainment element 6 with respect to the shaft bushing 5 is specified exactly when the two bearing surfaces 10, 73 are in contact with one another, since a fit is present between the base region 71 of the feather key 7 and the second recess. Since the entrainment element 6 holds the rotating slide ring 2, a position of the rotating slide ring 2 is thus also specified.

As can be seen in FIG. 1, it is thus possible in accordance with the invention to provide a mechanical seal arrangement which comprises only a very small number of parts. In accordance with the invention, the feather key 7 assumes not only the function of transmitting torque but also a function of positioning the entrainment 6 with respect to the shaft bushing 5. The first recess 8 can be produced in the entrainment element 6 in a very simple manner by means of a machining process. Therefore, a significant reduction in the cost of the mechanical seal arrangement can be achieved in accordance with the invention.

FIG. 4 shows an alternative design of the feather key 7 in accordance with a second exemplified embodiment of the invention. As can be seen in FIG. 4, the feather key 7 of the second exemplified embodiment likewise comprises a base region 71 and an upper end region 72 which is formed in an arcuate manner. However, in contrast to the first exemplified embodiment, the feather key 7 of the second exemplified embodiment comprises a first rounded end face 74 and a second rounded end face 75. In this case, the first rounded end face 74 forms a bearing surface for the feather key 7 which is in contact with a bearing surface on the entrainment element 6. The bearing surface on the entrainment element 6 can likewise be produced by means of a milling process, wherein a radius of the milling tool or of the recess formed in the entrainment element 6 by the milling tool corresponds to a radius of the first rounded end face 74. This can also ensure in a simple manner a fit between the feather key 7 and the entrainment element 6.

FIG. 5 shows a mechanical seal arrangement 1 in accordance with a third exemplified embodiment of the invention. As can be seen in FIG. 5, the mechanical seal arrangement 1 comprises a first mechanical seal 51 and a second mechanical seal 52. The first mechanical seal 51 corresponds to the arrangement described in FIG. 1. The feather key 7 lies with the planar bearing surface 73 against the planar bearing surface 10. It should be noted that the feather key 7 can also be formed with a rounded end face as per FIG. 4, so that a linear contact would be produced between the end face of the feather key and the planar bearing surface 10. The second mechanical seal 52 comprises a second rotating slide ring 102, a second stationary slide ring 103 and a second entrainment element 16. The second entrainment element 16 is connected to the one-piece shaft bushing 5 by means of a clamping screw 14. The mechanical seal arrangement of the third exemplified embodiment as shown in FIG. 5 is a so-called tandem arrangement in which two mechanical seals are connected in series. In this case, a barrier fluid (arrow A) is supplied to the two mechanical seals through a channel 17. It should be noted that, of course, torque can likewise be transmitted at the second mechanical seal 52 between the shaft bushing 5 and the second entrainment element 16 by means of a feather key in accordance with the invention.

### LIST OF REFERENCE NUMERALS

1 mechanical seal arrangement

2 rotating slide ring

3 stationary slide ring

4 sealing gap

5 shaft bushing

6 entrainment element

7 feather key

8 first recess

9 second recess

10 bearing surface

11 housing

12 O-ring

13 O-ring

14 clamping screw

16 second entrainment element

17 channel

51 first mechanical seal

52 second mechanical seal

71 base region

72 upper end region

73 bearing plane

74 first rounded end face

75 second rounded end face

1. A mechanical seal arrangement, comprising:
at least one first mechanical seal having a rotating slide ring and a stationary slide ring which define a sealing gap therebetween;
a rotation component;
an entrainment element for transmitting a rotation of the rotation component to the rotating slide ring; and
at least one feather key which is arranged between the rotation component and the entrainment element in order to permit torque transmission between the rotation component and the entrainment element, wherein the feather key comprises a base region and an upper end region, and wherein the upper end region is formed in an arcuate manner.

2. A mechanical seal arrangement as recited in claim 1, wherein the entrainment element comprises an axial bearing surface against which the feather key lies.

3. A mechanical seal arrangement as recited in claim 1, wherein the rotation component is a one-piece shaft bushing.

4. A mechanical seal arrangement as recited in claim 1, wherein the upper end region of the feather key has a semi-circular cross-section.

5. A mechanical seal arrangement as recited in claim 4, wherein the semi-circular upper end region extends over an entire axial length of the feather key.

6. A mechanical seal arrangement as recited in claim 4, wherein the feather key comprises a planar bearing surface which lies against the axial bearing surface of the entrainment element.

7. A mechanical seal arrangement as recited in claim 2, wherein the feather key comprises at least one first rounded end face.

8. A mechanical seal arrangement as recited in claim 7, wherein the feather key comprises a second rounded end face.

9. A mechanical seal arrangement as recited in claim 1, wherein the entrainment element comprises a recess for partially receiving the feather key, wherein the recess is a milled recess having an arcuate shape.

10. A mechanical seal arrangement as recited in claim 1, wherein a multiplicity of feather keys are arranged at uniform spaced intervals along a periphery of the shaft bushing.

11. A mechanical seal arrangement as recited in claim 1, comprising a second mechanical seal having a second rotating slide ring and a second stationary slide ring.
